(19) United States
(12) Patent Application Publication
(10) Pub. No.: US 2025/0234417 A1
(43) Pub. Date: Jul. 17, 2025

(54) SURVIVAL TIME STATE HANDLING

(71) Applicant: Nokia Technologies Oy, Espoo (FI)

(72) Inventors: Deepa MALAPATI RAVINDRAIAH, Bangalore (IN); Ping-Heng KUO, Cambridge (GB); Zexian LI, Es[pp (FI)

(21) Appl. No.: 18/701,688

(22) PCT Filed: Oct. 12, 2022
(86) PCT No.: PCT/EP2022/078406

§ 371 Date: Apr. 16, 2024

(30) Foreign Application Priority Data
Oct. 20, 2021 (IN) 202141047572

(51) Int. Cl. H04W 76/25

(52) U.S. Cl. CPC H04W 76/25

(57) ABSTRACT

In response to determining by a network node that a user equipment is to enter a survival time state for at least one data packet, configuring the network node according to a predefined survival time configuration for reception of data from the user equipment in the survival time state.

### TECHNICAL FIELD

Various example embodiments relate to telecommunication systems, and more particularly to a network node for survival time state handling.

### BACKGROUND

The fifth generation wireless networks (5G) refer to a new generation of radio systems and network architecture. 5G is expected to provide higher bitrates and coverage than the current long term evolution (LTE) systems. 5G is also expected to increase network expandability up to hundreds of thousands of connections. However, there is a need to improve the communication services provided at these systems.

### SUMMARY

Example embodiments provide a network node for a communication system, the network node serving a user equipment, the network node comprising means being configured for: in response to determining that the user equipment is to enter a survival time state for at least one data packet, configuring the network node according to a predefined survival time configuration for reception of data from the user equipment in the survival time state. The network node is configured according to the predefined survival time configuration for reception of the at least one data packet and associated copies from the user equipment in the survival time state.

In one example, the means comprises at least one processor, and at least one memory including computer program code, the at least one memory and the computer program code being configured to, with the at least one processor, cause the performance of the network node.

Example embodiments provide a method comprising: in response to determining by a network node that a user equipment is to enter a survival time state for at least one data packet, configuring the network node according to a predefined survival time configuration for reception of data from the user equipment in the survival time state.

Example embodiments provide a computer program comprising instructions for causing a network node for performing at least the following: in response to determining that a user equipment is to enter a survival time state for at least one data packet, configuring the network node according to a predefined survival time configuration for reception of data from the user equipment in the survival time state.

### BRIEF DESCRIPTION OF THE DRAWINGS

The accompanying figures are included to provide a further understanding of examples, and are incorporated in and constitute part of this specification. In the figures:

FIG. 1 illustrates a part of an exemplifying radio access network;

FIG. 2 is a schematic illustration of a communication system;

FIG. 3A is a diagram of a protocol stack to an example of the present subject matter;

FIG. 3B is a diagram of a protocol stack to an example of the present subject matter;

FIG. 4 is a flowchart of a method at a network node according to an example of the present subject matter;

FIG. 5A is a flowchart of a method at a packet data convergence protocol (PDCP) entity according to an example of the present subject matter;

FIG. 5B is a Downlink Data Delivery Status (DDDS) message according to an example of the present subject matter;

FIG. 5C is a downlink (DL) USER DATA message according to an example of the present subject matter;

FIG. 6 is a flowchart of a method at a PDCP entity according to an example of the present subject matter;

FIG. 7 is a flowchart of a method at a medium access control (MAC) entity according to an example of the present subject matter;

FIG. 8 is a block diagram showing an example of an apparatus according to an example of the present subject matter.

### DETAILED DESCRIPTION

In the following description, for purposes of explanation and not limitation, specific details are set forth such as particular architectures, interfaces, techniques, etc., in order to provide a thorough understanding of the examples. However, it will be apparent to those skilled in the art that the disclosed subject matter may be practiced in other illustrative examples that depart from these specific details. In some instances, detailed descriptions of well-known devices and/or methods are omitted so as not to obscure the description with unnecessary detail.

The communication system may support one or more radio access technologies (RATs). A radio access technology of the radio access technologies may, for example, be evolved universal terrestrial radio access (E-UTRA) or 5G new radio (NR), but it is not limited to, as a person skilled in the art may apply the present subject matter to other communication systems provided with necessary properties. The communication system comprises network nodes such as base stations. The network node may serve user equipments located within the network node's geographical area of service or cell. Time-frequency resources of the communication system may be used for carrying information. The resources may be termed physical channels. The physical channels may be specified for uplink (UL) and downlink (DL) transmission of data. The physical channels may, for example, comprise a physical uplink shared channel (PUSCH), physical downlink control channel (PDCCH), physical random access channel (PRACH) etc.

The network node refers to a network node serving wireless devices and/or being operatively connected to other network nodes or network elements. Each network node may be provided as a Node B, a base station, a multi-standard radio (MSR) radio node such as an MSR BS, an e Node B, a network controller, a radio network controller (RNC), a base station controller, a relay, a donor node controlling relay, a base transceiver station (BTS), an access point (AP), a transmission point, a transmission node, a remote radio unit (RRU), a remote radio head (RRH), a node in distributed antenna system (DAS), moving/mobile node etc.

The characteristics of a telecommunications service provided by the communication system may be quantified by quality of service (QoS) parameters. These characteristics may bear the ability of the telecommunication system to satisfy stated and implied needs of the user of the service. One of the important QoS parameters may be the survival time. The survival time expresses as a time period or, especially with cyclic/periodic traffic, a maximum number of consecutive incorrectly received and/or lost packets that can be tolerated by an application. For example, the survival time may be the time that an application consuming a communication service may continue without an anticipated message. The application may, for example, be a remote robot control application that uses the user equipment to transmit control messages or packets via the network node to a robot. Using the survival time may enable to meet the strict communication service availability requirements.

The survival time may be used to prevent that the application becomes unavailable after the expiry of that time. For example, the application may be operational as long as the data packets are correctly received at the network node within the expected latency deadline. Assuming periodic traffic, in case some packets are lost or not correctly received within the latency deadline, the survival time may enable the application to be still operational/functional for some period of time (e.g., up to N (e.g., N=3) consecutive packets corresponding to the survival time), but would become unavailable if, for example, N+1 or more consecutive packets are not correctly received by the receiving node.

Taking UL data transmission as example, on the event when a given application of the user equipment loses communication because a certain number of consecutive packets are not correctly received at the network node, the user equipment may enter a survival time state. The user equipment may be in the survival time state during the survival time. Before entering the survival time state, the user equipment may have transmitted an initial set of data packets (e.g., NO packets) of an application, wherein the survival time state is caused by at least one failed reception of a packet of the application. After entering the survival time state, the user equipment may transmit further/subsequent packets (e.g., N1 packets, where N1≥1) of the application e.g., with higher reliability using the duplication technique. The data packets of the application may, for example, be transmitted using a data radio bearer (DRB). In this case, the user equipment is said to be in the survival time state for the DRB. The network node is configured according to the predefined survival time configuration for reception of the N1 data packets and associated copies from the user equipment in the survival time state.

A DRB may enable to transport the packets between the user equipment and the network node. A bearer may refer to an information transmission path of defined characteristics such as capacity, delay and bit error rate. A data radio bearer may refer to a service provided by the Layer 2 transfer for user data between a user equipment and the network node. The data radio bearer may, for example, be configured with a first set of resources. The first set of resources may comprise entities and logical channels which may be used to transmit data. The data radio bearer may further be configured with additional resources which are inactive and not used for data transmission while they are inactive. The data radio bearer may be changed or reconfigured with a second set of resources. The second set of resources may, for example, be obtained by activating at least part of the additional resources so that the second set of resources may comprise the first set of resources and the at least part of the additional resources.

For example, the user equipment may be configured to perform data transmissions for an application with a (default) first set of transmission parameters. The first set of parameters may, for example, comprise the first set of resources of the DRB. In the survival time state, the user equipment may be configured to perform data transmissions with a second set of transmission parameters. The second set of parameters may, for example, comprise the second set of resources of the DRB. The data transmissions with the second set of transmission parameters may provide higher radio link reliability than those with the first set of transmission parameters, in order to reduce the probability of consecutive errors (including decoding error and/or packet loss and/or delivering out of the packet delay budget) and thus prevent the application from becoming unavailable. Each parameter of the first and second sets of parameters may, for example, comprise a Modulation and Coding Scheme (MCS), a frequency-time resource allocation, a number of time/frequency/spatial-domain repetitions, a number of PDCP duplication legs, or a set of active RLC entities.

The user equipment may be configured to transmit a set of data packets. The set of data packets may comprise data packets of one or more applications of the user equipment. Some or all of the applications may be configured with survival time requirement. The set may comprise multiple subsets. Each subset of the subsets may, for example, comprise data packets of a respective application of the applications. In one example, the number of subsets may be equal to the number of applications but it is not limited to. The user equipment may be configured to transmit the multiple subsets according to one or more RDBs. For example, the user equipment may be configured to transmit each subset of the set according to a distinct DRB. The user equipment may enter the survival time state for at least one subset of the set of an application with survival time requirement. This may, for example, mean that the user equipment enters the survival time state for the DRB (DRB with survival time requirement) associated with said subset. After entering the survival time state for the subset, the user equipment may transmit the data packets of the subset that are buffered but not yet transmitted using the second set of transmission parameters.

The transmission of data using the second set of transmission parameters may, for example, enable packet duplication (or modify duplication setting) at the user equipment in the survival time state. The user equipment may be configured with the packet duplication for the DRB using the second set of parameters. The configuration of the packet duplication for the DRB at the transmitter side is enabled by a set of protocol entities and a set of logical channels. The set of logical channels may comprise a primary logical channel for the transmission of the original/initial copy of the packet and one or more secondary logical channels for the transmission of one or more copies of the packet respectively. The set of configured logical channels of the DRB may belong to the same MAC entity for enabling the packet duplication based on Carrier Aggregation (CA). The set of configured logical channels of the DRB may, in another example, belong to different MAC entities for enabling the packet duplication based e.g., on Dual Connectivity (DC) or DC in conjunction with CA.

The present subject matter may be advantageous as it may configure the network node in time. This configuration may enable to adapt reception features of the network to the new transmission scheme of the user equipment by switching the network node from a first (default) state to a second state. Indeed, the network node may be configured in the first default state according to a first set of reception parameters in order to receive data from the user equipment, wherein the received data is transmitted by the user equipment according to the first set of transmission parameters (i.e., the first set of reception parameters of the network node corresponds with the first set of transmission parameters of the user equipment). The network node may be configured in the second state according to the second set of reception parameters in order to receive data from the user equipment, wherein the received data is transmitted by the user equipment according to the second set of transmission parameters (i.e., the second set of reception parameters of the network node corresponds with the second set of transmission parameters of the user equipment).

The network node may advantageously be configured to switch between the first state and the second state. According to one example, in response to determining that the user equipment is to enter the survival time state (e.g., for at least one DRB), the network node may switch from the first state to the second state (e.g., for at least one DRB) for enabling the network node to receive data (e.g., of the corresponding DRB(s)) from the user equipment in the survival time state. The switching may, for example, be performed in response to the determining that the user equipment is to enter the survival time state. For example, when entering the survival time state for one DRB, the user equipment may reconfigure the DRB; thus, in response to determining by the network node that the user equipment is to enter (or going to enter or will enter) the survival time state, the network node may switch to the second state in order to receive data, wherein the data is transmitted using the reconfigured DRB.

According to one example, in response to determining that the user equipment is to enter the survival time state, the network node may be configured according to the predefined survival time configuration for reception of data from the user equipment in the survival time state. The predefined survival time configuration may, for example, be decided by the network node. The predefined survival time configuration may, for example, be defined by the second set of reception parameters that enables the network node to receive data from the user equipment while the user equipment is in the survival time state, wherein the received data is transmitted by the user equipment according to the second set of transmission parameters.

The present subject matter may thus improve the efficiency of the operation of the communication system during the survival time state of the user equipment. Indeed, configuring the network node immediately before the user equipment autonomously switches to the survival time state, may ensure that transmission/reception configurations are synchronized between the user equipment and the network node. This may enable to better make use of the survival time, to reduce the reception error and thus meet the strict communication service availability values asserting that the communication service has to be re-established with almost 100% guarantee without violating the survival time requirement.

The probability of detecting that the user equipment is to enter the survival time state may not be 100% due to different issues. The present subject matter may further be advantageous as it may increase the probability of detecting that the user equipment is to enter the survival time state because the network node may use several criteria to determine that the user equipment is going to enter the survival time state. According to one example, determining that the user equipment is to enter the survival time state comprises checking if at least one criterion of a set of criteria is fulfilled. A first criterion of the set of criteria may, for example, require the detection of a failure to receive at least one packet from the user equipment.

When an uplink (UL) PUSCH transmission fails, the network node may trigger a dynamic retransmission grant (e.g., indicated via downlink control information (DCI) in the PDCCH) to retransmit the incorrectly received data. In addition to the retransmission, the reception of such retransmission grant at the user equipment may instruct the user equipment to enter the survival time state. Therefore, a second criterion of the set of criteria may require the identification of a necessity of transmission of a retransmission grant or a configured grant activation command to the user equipment. A third criterion of the set of criteria may require the transmission by the network node of a retransmission grant or a configured grant activation command to the user equipment.

The user equipment may start a timer with the transmission of a packet, and if the user equipment does not receive an acknowledgement (ACK) or a not-acknowledgment (NACK) of the packet or a retransmission grant for the packet (e.g. implicit NACK), the user equipment may autonomously enter the survival time state for the next packet. The same timer may be deployed at the network node so the network node may decide if the user equipment will enter the survival time state based on the timer status. Therefore, a fourth criterion of the set of criteria may require a given status for the timer.

In one example, the survival time state may be determined by the packet sequence number (SN), so the user equipment may autonomously enter the survival time state for e.g., every odd-indexed packet. Since at periodic traffics, the network node expects the arrival time of each packet and there it can decide if the survival time state will be triggered based on the sequence number (e.g., if the network node receives the packet with SN=2, then it knows the survival time state should be triggered for the next packet whose SN is supposed to be 3, which is odd-valued). Therefore, a fifth criterion of the set of criteria may require a given value type of a sequence number of the received packet.

Hence, determining that the user equipment is to enter the survival time state comprises detecting by the network node a trigger of the survival time state. This trigger may cause the user equipment to enter the survival time state.

The communication system may enable data communication between network nodes and user equipments using a radio interface protocol. The radio interface protocol may comprise a user plane protocol, used for the transfer of user data (e.g., IP packets) between the network node and the user equipment, and a control plane protocol that is used for control signalling between the network node and the user equipment. Layers of the radio interface protocol may be classified into a first layer (L1 or Layer 1), a second layer (L2 or Layer 2), and a third layer (L3 or Layer 3) based on the lower three layers of the open system interconnection (OSI) model.

The configuration of the network node in order to receive data from the user equipment in the survival time state, may be performed by activating a duplication function (named new duplication function) in one or more protocol entities of the second layer of the radio interface protocol. Activating the duplication function may, for example, enable the network node to receive at least one copy of a packet from the user equipment. Activating the duplication function may, for example, enable the network node to receive and identify one or more duplicate packets of a packet previously received from the user equipment.

A protocol entity refers to a functional entity, which may be implemented by software and/or hardware. The protocol entity may be configured to implement tasks of a protocol layer and control the sending and receiving of primitives between protocol entities. In one example, the protocol entity may be (pre)configured with the duplication function, wherein the duplication function is not activated while the protocol entity itself is activated. In this case, the duplication function may be activated within the protocol entity. In another example, activating the duplication function in at least one protocol entity may comprise activating the at least one protocol entity if the at least one protocol entity is not activated originally. In another example, a previous duplication function may already be activated at the network node for communication of data between the user equipment and the network node. In this case, activating the new duplication function may comprise modifying the existing active duplication function.

The activation of the duplication function in the one or more protocol entities may enable to configure the duplication for the DRB at the receiver side. The activation of the duplication function in the one or more protocol entities may enable the network node to receive an original packet and one or more copies of the data packet via a primary logical channel and one or more secondary logical channels respectively. The logical channels may belong to the network node for enabling the packet duplication based on Carrier Aggregation (CA). The logical channels may, in another example, belong to different network nodes for enabling the packet duplication based on Dual Connectivity (DC).

The layers of the radio interface protocol may be defined as follows. A physical layer belongs to the first layer L1. The physical layer provides a higher layer with an information transfer service through physical channels. The physical layer provides its services to a medium access control (MAC) layer via transport channels. The MAC layer belongs to the second layer L2. The MAC layer provides services to a radio link control (RLC) layer, which is a higher layer of the MAC layer, via logical channels. The MAC layer provides a function of mapping multiple logical channels to multiple transport channels. The MAC layer also provides a function of logical channel multiplexing by mapping multiple logical channels to a single transport channel. The RLC layer belongs to the second layer L2. The RLC layer may provide a function of adjusting a size of data, so as to be suitable for a lower layer to transmit the data, by concatenating and segmenting the data received from a higher layer in a radio section. A packet data convergence protocol (PDCP) layer belongs to the second layer L2. The PDCP layer provides a function of header compression function that reduces unnecessary control information such that data being transmitted by employing IP packets, such as IPv4 or IPv6, can be efficiently transmitted over a radio interface that has a relatively small bandwidth.

The network node may activate the duplication function in at least one of MAC entity of the MAC layer, RLC entity of the RLC layer and PDCP entity of the PDCP layer.

According to an example, the PDCP entity may be configured to receive a first notification from a protocol entity of the second layer. The first notification indicates that the user equipment is to enter the survival time state. In response to receiving the first notification, the PDCP entity may activate the duplication function in the one or more protocol entities.

According to an example, the MAC entity is configured to detect the failure and in response to the failure send to the user equipment a retransmission grant of a hybrid automatic repeat request (“HARQ”) process or a configured grant activation command.

According to an example, the protocol entity is configured to send the first notification upon determining that the user equipment is to enter the survival time state. The protocol entity that sends the first notification is a RLC entity or MAC entity.

According to an example, the PDCP entity is configured to activate the duplication function in the RLC and/or MAC entities by sending a message with an information element indicating the activation. The message may, for example, be the existing message DL USER DATA (PDU Type 0) which is modified to include the information element indicating the activation.

According to an example, the first notification is received via a F1-U interface, wherein the message (e.g., DL USER DATA message) is sent over the F1-U interface. This means that the duplication function is configured in CA mode.

According to an example, the duplication function is configured in a dual connectivity mode involving a secondary network node, wherein the first notification is received via a Xn-U interface from the secondary network node. The PDCP entity is configured to activate the duplication function in DA mode by sending a message (e.g., DL USER DATA message) over the Xn-U interface to the secondary network node. For example, at the secondary network node, once a packet is lost, the secondary network node is triggered to send the first notification to the network node via the Xn-U interface.

According to an example, the first notification is a Downlink Data Delivery Status (DDDS) message (PDU Type 1) comprising an information element indicating that the user equipment is to enter the survival time state.

According to an example, the PDCP entity is configured to: receive a second notification from a protocol entity of the second layer. The second notification indicates that the user equipment is leaving the survival time state. In response to receiving the second notification, the PDCP entity may deactivate the duplication function in said one or more protocol entities.

According to an example, the PDCP entity is configured to perform the deactivation of the duplication function in the RLC and/or MAC entities by sending a message with an information element indicating the deactivation. The message may, for example, be the existing message DL USER DATA (PDU Type 0) which is modified to include the information element indicating the deactivation.

The deactivation of the duplication function may comprise switching the network node to the first state.

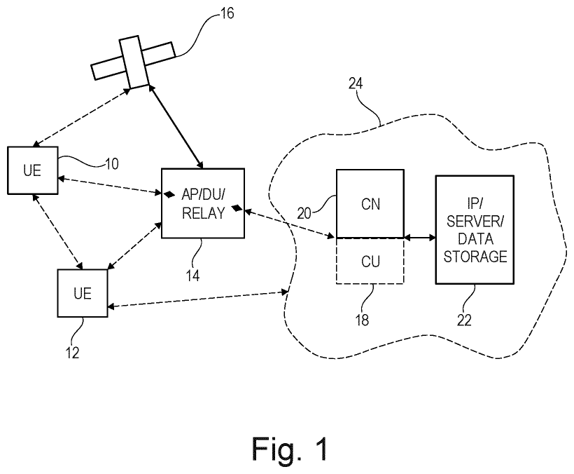

FIG. 1 depicts example of simplified system architecture showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows devices 10 and 12. The devices 10 and 12 may, for example, be user devices. The devices 10 and 12 are configured to be in a wireless connection on one or more communication channels with a node 14. The node 14 is further connected to a core network 20. In one example, the node 14 may be an access node (such as (e/g)NodeB) 14 providing or serving devices in a cell. In one example, the node 14 may be a non-3GPP access node. The physical link from a device to a (e/g)NodeB is called uplink or reverse link and the physical link from the (e/g)NodeB to the device is called downlink or forward link. It should be appreciated that (e/g)NodeBs or their functionalities may be implemented by using any node, host, server or access point etc. entity suitable for such a usage. The node 14 may, in one example, be a IAB node comprising an IAB-DU and IAB-MT.

A communications system typically comprises more than one (e/g)NodeB in which case the (e/g)NodeBs may also be configured to communicate with one another over links, wired or wireless, designed for the purpose. These links may be used for signaling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to devices. The antenna unit may comprise a plurality of antennas or antenna elements. The (e/g)NodeB is further connected to the core network 20 (CN or next generation core NGC). For example, the (e/g)NodeB may connect to an access and mobility management function (AMF) and user plane function (UPF) in the control plane and user plane, respectively. Depending on the system, the counterpart on the CN side can be a serving gateway (S-GW, routing and forwarding user data packets), packet data network gateway (P-GW), for providing connectivity of devices (UEs) to external packet data networks, or mobile management entity (MME), etc.

The device (also called user device, UE, user equipment, user terminal, terminal device, etc.) illustrates one type of an apparatus to which resources on the air interface are allocated and assigned, and thus any feature described herein with a device may be implemented with a corresponding apparatus, such as a relay node. An example of such a relay node is a layer 3 relay (self-backhauling relay) towards the base station.

The device typically refers to a device (e.g. a portable or non-portable computing device) that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a device may also be a nearly exclusive uplink only device, of which an example is a camera or video camera loading images or video clips to a network. A device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilize cloud. In some applications, a device may comprise a user portable device with radio parts (such as a watch, earphones or eyeglasses) and the computation is carried out in the cloud. The device (or in some embodiments a layer 3 relay node) is configured to perform one or more of user equipment functionalities. The device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than an existing LTE system (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet as illustrated by the component referenced by reference numeral 22, or utilize services provided by them. The communication network may also be able to support the usage of cloud services, for example at least part of core network operations may be carried out as a cloud service (this is depicted in FIG. 1 by “cloud” 24). The communication system may also comprise a central control entity, or a like, providing facilities for networks of different operators to cooperate for example in spectrum sharing.

The technology of Edge cloud may be brought into a radio access network (RAN) by utilizing network function virtualization (NVF) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 14) and non-real time functions being carried out in a centralized manner (in a centralized unit, CU 18).

It should also be understood that the distribution of labour between core network operations and base station operations may differ from that of the LTE or even be non-existent. Some other technology advancements probably to be used are Big Data and all-IP, which may change the way networks are being constructed and managed. 5G is being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano)satellites are deployed). Each satellite 16 in the mega-constellation may cover several satellite-enabled network entities that create on-ground cells. The on-ground cells may be created via an on-ground relay node 14 or by a gNB located on-ground or in a satellite.

It is understandable for a person skilled in the art that the depicted system is only an example of a part of a radio access system and in practice, the system may comprise a plurality of (e/g)NodeBs, the device may have an access to a plurality of radio cells and the system may comprise also other apparatuses, such as physical layer relay nodes or other network elements, etc. One of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

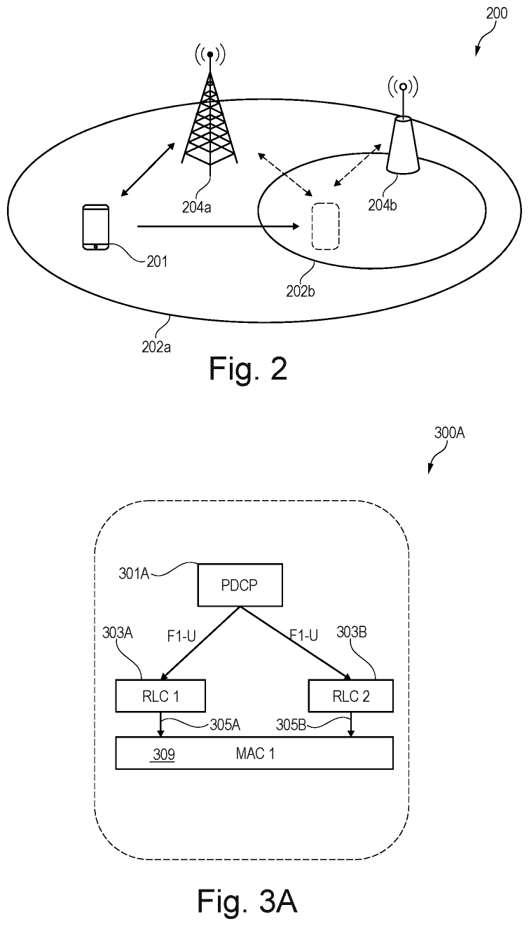

FIG. 2 is a schematic illustration of a wireless communication system 200. The communication system 200 may, for example, be configured to use a time division duplex (TDD) technique for data transmission.

For simplicity, communication system 200 is shown to include two base stations 204a and 204b and a UE 201. The base stations 204a-b may, for example, be eNodeBs and/or gNBs. That is, the communication system 200 may support a same RAT or different RATs.

Each of the base stations 204a-b may serve UEs within a respective geographical coverage area of service. The base station and its coverage area may collectively be referred to as a “cell”. The cells of the communication system 200 are labeled 202a and 202b.

As illustrated in FIG. 2, the UE 201 may be, in one example, served by the base station 202a only. In another example, the UE 201 may be served by the two base stations 204a and 204b in accordance with a dual connectivity mode. In this case, the base station 204a may be the master base station MgNB and the base station 204b may be the secondary base station SgNB.

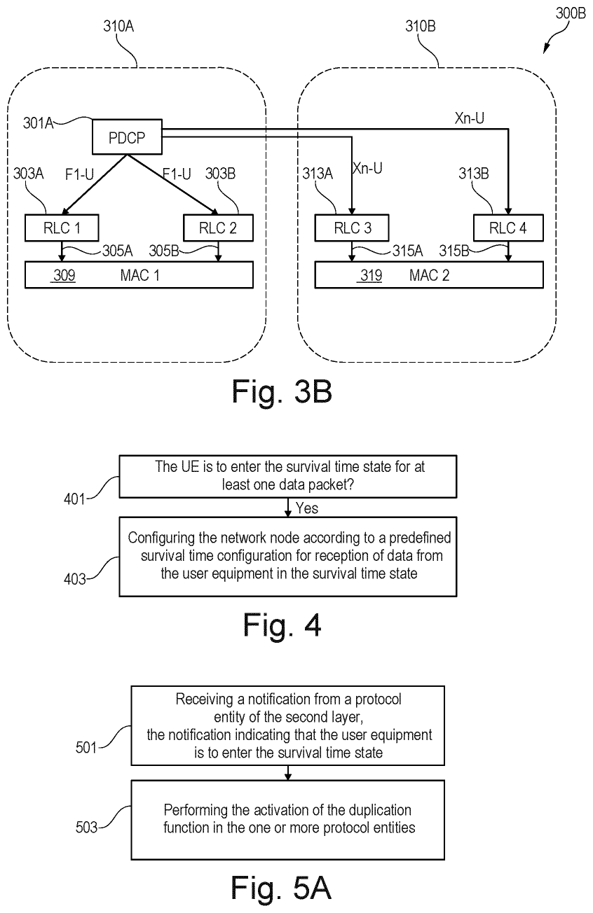

FIG. 3A depicts a protocol stack 300A for data duplication, according to an example of the present subject matter. The protocol stack 300A may be implemented within a network node, such as the base station 204a or 204b or 14. The protocol stack 300A includes a PDCP entity 301A located at the PDCP layer. The PDCP entity 301A is mapped to a number N of RLC entities via F1-U interfaces respectively, here N=2 for simplification of the description but it is not limited to. A first RLC entity 303A is associated with a first logical channel (LCH) 305A and a second RLC entity 303B is associated with a second logical channel 305B. Each RLC entity 303A and 303B is mapped to the same MAC entity 309. The protocol stack 300A may enable the duplication function. In this example, the protocol stack may support a PDCP duplication. The MAC entity 309 may send individual PDUs through individual LCHs 305A and 305B to individual RLC entities 303A-303B. Each of the RLC entities may transfer PDCP PDUs to the PDCP entity 301A. For example, the original PDCP data PDU (e.g., initial PDCP PDU) may be submitted by the first RLC entity 303A, while the duplicate PDCP data PDU may be submitted by the second RLC entity 303B. The PDCP entity 301 may be configured to receive and identify original and duplicate PDCP PDUs. The protocol stack 300A may enable the duplication in CA mode.

FIG. 3B depicts a protocol stack 300B for data duplication according to an example of the present subject matter. The protocol stack 300B comprises a first protocol component 310A and a second protocol component 310B. The protocol stack 300B may enable the dual connectivity mode of operation. The protocol stack 300B may be implemented within the base stations 204a and 204b. The first component 310A of the protocol stack 300B may be implemented within the master base station 204a and the second component 310B of the protocol stack 300B may be implemented within the secondary base station 204b. As shown in FIG. 3B, the first component 310A of the protocol stack 300B may be the protocol stack 300A as described in FIG. 3A. The second component 310B of the protocol stack 300B has a number N of RLC entities (here N=2 for simplification of the description but it is not limited to) which are mapped to the PDCP entity 301A via Xn-U interfaces. A first RLC entity 313A associated with a first logical channel 315A and a second RLC entity 313B associated with a second logical channel 315B. Each RLC entity 313A and 313B is mapped to the same MAC entity 319. The protocol stack 300B may enable the duplication in DC mode.

FIG. 4 is a flowchart of a method according to an example of the present subject matter. For the purpose of explanation, the method may be implemented in the system illustrated in previous FIG. 1 or FIG. 2, but is not limited to this implementation. The method may be performed by the network node, wherein the network node may, for example, be anyone of the node 14 of FIG. 1 and base stations 204a and 204b of FIG. 2.

The network node may check or determine in step 401 whether the user equipment 201 is to enter a survival time state for at least one data packet of an application. For example, the network node may determine in step 401 whether the user equipment 201 is to enter the survival time state for at least one data radio bearer that is used to transmit data of the application. The network node may determine that the user equipment is to enter the survival time state by checking if at least one criterion of a set of criteria is fulfilled.

A first criterion of the set of criteria may, for example, require the detection of a failure to receive at least one packet from the user equipment.

When an uplink (UL) PUSCH reception fails, the base station triggers a dynamic retransmission grant (e.g., indicated via downlink control information (DCI) in the PDCCH) or a configured grant activation command to retransmit the incorrectly received data. In addition to the retransmission, the reception of such retransmission grant at the user equipment may instruct the user equipment to switch to survival time state. Therefore, a second criterion of the set of criteria may require the identifying of a necessity of transmission of a retransmission grant or a configured grant activation command to the user equipment. A third criterion of the set of criteria may require the transmission by the network node of a retransmission grant or a configured grant activation command to the user equipment.

The user equipment may start a timer with the transmission of a packet, and if the user equipment does not receive an acknowledgement (ACK) or a no-acknowledgment (NACK) or a retransmission grant for the packet (e.g., implicit NACK) of the packet, the user equipment may autonomously enter the survival time state for the next packet. The same timer may be deployed at the base station so the base station can decide if the user equipment will enter the survival time state based on the timer status. Therefore, a fourth criterion of the set of criteria may require a given status for the timer.

In one example, the survival time state may be determined by the packet sequence number (SN), so the user equipment may autonomously enter the survival time state for e.g., every odd-indexed packet. Since at periodic traffics, the base station expects the arrival time of each packet and there it can decide if the survival time state will be triggered based on the sequence number (e.g., if the base station receives the packet with SN=2, then it knows the survival time state should be triggered for the next packet whose SN is supposed to be 3, which is odd-valued). Therefore, criterion of the set of criteria may require a given value type of a sequence number of the received packet

In case it is determined that the user equipment is to enter the survival time state, the network node may be configured in step 403 for reception of data from the user equipment in the survival time state. For example, the network node may be configured according to a predefined survival time configuration for reception of data from the user equipment in the survival time state. The network node may, for example, be configured in step 403 so that the duplication is configured for the at least one data radio bearer. For that, the configuring of the network node may be performed by activating the duplication function in one or more protocol entities of the second layer (Layer 2) of the radio interface protocol. This activation may enable the network node to receive and identify one or more duplicate packets of said at least one data packet received from the user equipment.

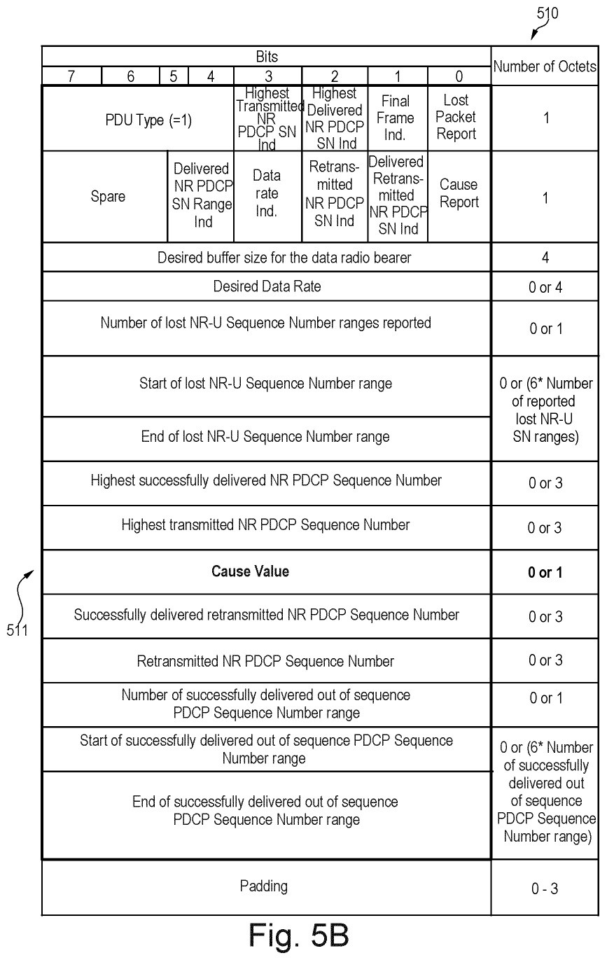

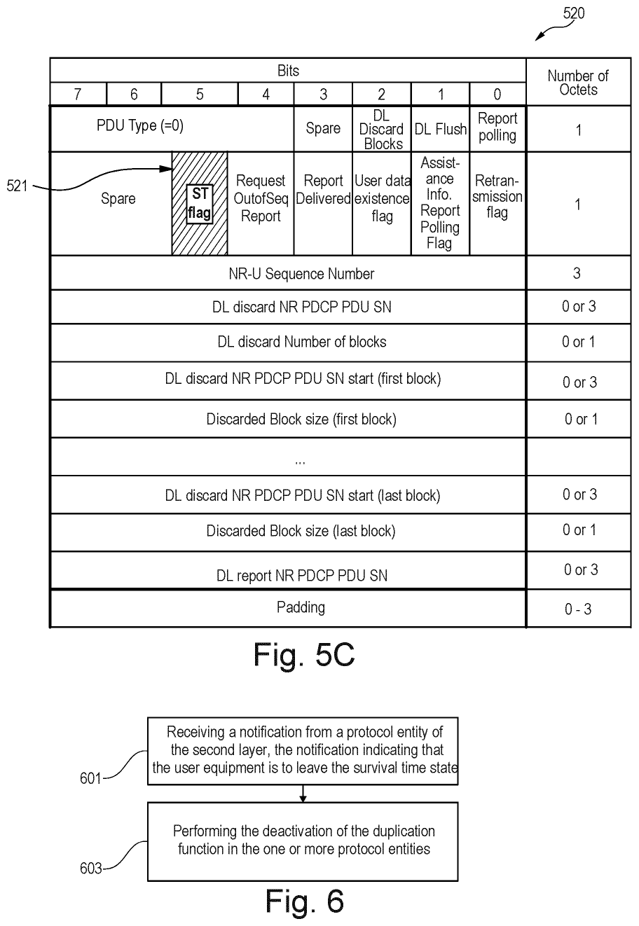

Following the example of the protocol stack 300A of FIG. 3A, before it is determined that the UE is going to enter the survival time state, the RLC entity 303B and the logical channel 305B may not be active and the duplication function may not be active in the PDCP entity 301A and/or MAC entity 309. Activating the duplication function comprises activating one or more entities for the creation of the duplicated packets and activating entities for the transmission of the duplicated packets. Thus, activating the duplication function in one entity means activating said entity for creation of duplicated packets and/or transmission of the duplicated packets. In this case, the network node may be configured in step 403 for reception of data from the user equipment in the survival time state by activating the RLC entity 303B, and activating the duplication function in the MAC entity 309 and/or the PDCP entity 301A. For example, the activation of the MAC entity 309 and the RLC entity 303B may result in activation of the logical channel 305B. Thus, the network node may be configured to receive the original packet through the logical channel 305A and the duplicate packet through the logical channel 305B. In this example, the network node activated the duplication function in the PDCP entity 301A, the MAC entity 309 and/or the RLC entity 303B. The network node may activate the duplication function in the PDCP entity 301A, the MAC entity 309 and the RLC entity 303B by sending a message such as the message of FIG. 5C with an information element indicating the activation. In response to receiving the message at each entity, the duplication function may be activated in said entity.

Following the example of the protocol stack of FIG. 3B, originally the PDCP entity of the user equipment only submits packets to RLC 1 303A and RLC 3 313A. After entering the survival time state, the PDCP entity of the user equipment may submit the packets to all of RLC entities, RLC 1, RLC 2, RLC 3, and RLC 4 303A-B and 313A-B. So, an existing active duplication function is changed so that the number of copies increases from 2 to 4 when the user equipment enters the survival time state.

FIG. 5A is a flowchart of a method at a PDCP entity according to an example of the present subject matter. For the purpose of explanation, the method may be implemented in the system illustrated in previous FIG. 1 or FIG. 2, but is not limited to this implementation. The PDCP entity may be hosted in anyone of the node 14 of FIG. 1 and base stations 204a and 204b of FIG. 2.

The PDCP entity 301A may receive in step 501 a notification from the RLC entity. The notification indicates that the user equipment 201 is to enter the survival time state. Depending on the protocol stack being used, the PDCP entity 301A may receive the notification from the RLC entity over F1-U interface or Xn-U interface. For example, with the protocol stack 300A, the PDCP entity 301A may receive the notification via a F1-U interface from the first RLC entity 303A. With the protocol stack 300B, the PDCP entity 301A may receive the notification via a Xn-U interface from the RLC entity 313A.

The notification may, for example, be triggered as follows. Upon triggering retransmission grant at gNB DU/MAC entity e.g., 309, the MAC entity e.g., 309 may inform the RLC entity e.g., 303A about the entering to the survival time state. The RLC entity may inform the PDCP entity about the survival time state using the notification.

In one example, the notification may be the DDDS-PDU Type 1 message. FIG. 5B shows an example content of the DDDS message 510 according to the present subject matter. The present method may extend the usage of the existing DDDS message (as described in TS 38.425 V16.3.0 section 5.5.2.2) with an additional information as follows.

As indicated in FIG. 5B, the DDDS message 510 comprises an information element 511 or field called “Cause Value”. The information element “Cause Value” indicates specific events reported by the corresponding node and the value range is as follows: {0=UNKNOWN, 1=RADIO LINK OUTAGE, 2=RADIO LINK RESUME, 3=UL RADIO LINK OUTAGE, 4=DL RADIO LINK OUTAGE, 5=UL RADIO LINK RESUME, 6=DL RADIO LINK RESUME, 7-228=reserved for future value extensions, 229-255=reserved for test purposes}.

To indicate the survival time state in the DDDS message 510, new cause values of the information element “Cause Value” may be added as follows: {0=UNKNOWN, 1=RADIO LINK OUTAGE, 2=RADIO LINK RESUME, 3=UL RADIO LINK OUTAGE, 4=DL RADIO LINK OUTAGE, 5=UL RADIO LINK RESUME, 6=DL RADIO LINK RESUME, 7=ENTER SURVIVAL TIME STATE, 8=EXIT SURVIVAL TIME STATE, 9-228=reserved for future value extensions, 229-255=reserved for test purposes}

The new value “7” of the “Cause Value” in the DDDS message can be applied by MAC/RLC entity to notify the PDCP entity. The DDDS message with cause value=ENTER SURVIVAL TIME STATE may indicate to the PDDP entity in step 501 that the user equipment is to enter the survival time state for a DRB.

In response to receiving the notification, the PDCP entity may perform in step 503 the activation of the duplication function in one or more protocol entities. For example, the PDCP entity may switch its configuration (e.g., change the set of RLC entities to process data packets of the DRB) as a response to survival time state triggering. The PDCP entity may enable the duplication function in itself as well as in the RLC and/or MAC entities. The PDCP entity may activate duplication over multiple legs. For that, the PDCP entity may activate the duplication function in the RLC and/or MAC entities by for example sending to these entities the DL USER DATA message 520 shown in FIG. 5C with an information element indicating the activation. The DL USER DATA message may be DL USER DATA (PDU Type 0) (e.g., as described in TS 38.425 V16.3.0 section 5.5.2.1). The DL USER DATA message may be sent over F1-U or Xn-U interfaces depending on the protocol stack being considered.

The existing DL USER DATA message format is extended with a new information element 521 “ST flag” as shown in FIG. 5C, ST stands for survival time. The ST flag may be set to value 1 to indicate that the survival time state is enabled, and value 0 to indicate that the survival time state is disabled.

Upon reception of ST flag=1 at RLC, the RLC/MAC entity may switch the parameters for reception of the uplink packets to boost reliability based on the configured schemes for survival time state. For example, some RLC entities may be activated (when survival time state enabled) or deactivated (when survival time state disabled) upon reception of this message from the PDCP entity. Alternatively, the MAC entity may change configuration or parameters of certain LCHs after receiving such message from the PDCP entity. Upon reception of ST flag=0 at the RLC, the RLC/MAC entity may switch back to the reception scheme for normal state.

FIG. 6 is a flowchart of a method at a PDCP entity according to an example of the present subject matter. For the purpose of explanation, the method may be implemented in the system illustrated in previous FIG. 1 or FIG. 2, but is not limited to this implementation. The PDCP entity may be hosted in anyone of the node 14 of FIG. 1 and base stations 204a and 204b of FIG. 2.

The PDCP entity 301A may receive in step 601 a notification from a protocol entity of the second layer. The notification indicates that the user equipment is leaving the survival time state. The notification may, for example, be the DDDS message 510 in which the information element 511 is set to cause value 8 i.e., cause value=EXIT SURVIVAL TIME STATE.

In response to receiving the notification, the PDCP entity 301A may deactivate in step 603 the duplication function in one or more protocol entities. The PDCP entity 301A may switch to the parameters that are pre-configured for the normal state of operation for example after a MAC CE for uplink PDCP duplication control (e.g., Duplication RLC Activation/Deactivation MAC CE specified in TS38.321) is transmitted to the UE so that the UE leaves the survival time state.

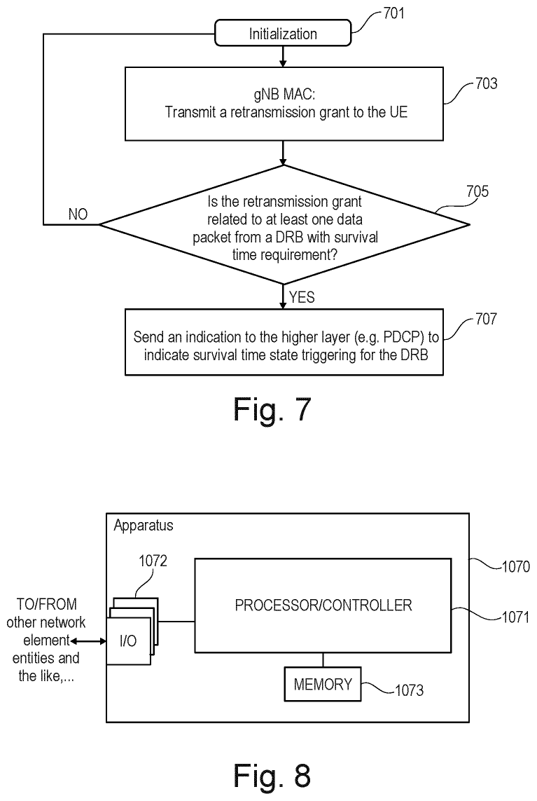

FIG. 7 is a flowchart of a method at a MAC entity according to an example of the present subject matter. For the purpose of explanation, the method may be implemented in the system illustrated in previous FIG. 1 or FIG. 2, but is not limited to this implementation. The MAC entity may, for example, be hosted in anyone of the node 14 of FIG. 1 and base stations 204a and 204b of FIG. 2.

The MAC entity may transmit in step 703 a retransmission grant to the user equipment. The transmission may be performed in response, for example, to a failure to receive/decode a packet from the user equipment in an initialization step 701.

The MAC entity may determine in step 705 if the retransmission grant related to the data packet is from a DRB with survival time requirement or not. Since survival time may mainly be required for periodic traffic, the use of configured grant and LCH mapping restriction may be anticipated in practice. Based on this, the MAC entity may recognize if an erroneously detected transport block contains any data from the DRB with survival time requirement based on the type or configuration of the corresponding uplink grant. For instance, if the erroneously decoded PUSCH pertains to a configured grant associated to certain LCHs (based on LCH mapping restriction) corresponding to DRBs with survival time requirement, then it is straightforward for the gNB to know what data is included in the transport block even without decoding it successfully.

In one example, step 705 may be executed before executing step 703 or concurrently with execution of step 703.

In case the retransmission grant related to the data packet from a DRB with survival time requirement, the MAC entity may send in step 707 an indication of entering the survival time state to a higher layer.

In FIG. 8, a block circuit diagram illustrating a configuration of an apparatus 1070 is shown, which is configured to implement at least part of the present subject matter. It is to be noted that the apparatus 1070 shown in FIG. 8 may comprise several further elements or functions besides those described herein below, which are omitted herein for the sake of simplicity as they are not essential for the understanding. Furthermore, the apparatus may be also another device having a similar function, such as a chipset, a chip, a module etc., which can also be part of an apparatus or attached as a separate element to the apparatus 1070, or the like. The apparatus 1070 may comprise a processing function or processor 1071, such as a central processing unit (CPU) or the like, which executes instructions given by programs or the like related to a flow control mechanism. The processor 1071 may comprise one or more processing portions dedicated to specific processing as described below, or the processing may be run in a single processor. Portions for executing such specific processing may be also provided as discrete elements or within one or more further processors or processing portions, such as in one physical processor like a CPU or in several physical entities, for example. Reference sign 1072 denotes transceiver or input/output (I/O) units (interfaces) connected to the processor 1071. The I/O units 1072 may be used for communicating with one or more other network elements, entities, terminals or the like. The I/O units 1072 may be a combined unit comprising communication equipment towards several network elements or may comprise a distributed structure with a plurality of different interfaces for different network elements. Reference sign 1073 denotes a memory usable, for example, for storing data and programs to be executed by the processor 1071 and/or as a working storage of the processor 1071.

The processor 1071 is configured to execute processing related to the above described subject matter. In particular, the apparatus 1070 may be configured to perform at least part of the method as described in connection with FIG. 4, FIG. 5A or FIG. 6.

For example, the processor 1071 is configured for: in response to determining that a user equipment is to enter a survival time state, configuring a base station according to a predefined survival time configuration for reception of data from the user equipment in the survival time state.

As will be appreciated by person skilled in art, aspects of the present invention may be embodied as an apparatus, method, computer program or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer executable code embodied thereon. A computer program comprises the computer executable code or “program instructions”.

Any combination of one or more computer readable medium(s) may be utilized. The computer readable medium may be a computer readable storage medium. A ‘computer-readable storage medium’ as used herein encompasses any tangible storage medium which may store instructions which are executable by a processor of a computing device. The computer-readable storage medium may be referred to as a computer-readable non-transitory storage medium. The computer-readable storage medium may also be referred to as a tangible computer readable medium. In some embodiments, a computer-readable storage medium may also be able to store data which is able to be accessed by the processor of the computing device.

‘Computer memory’ or ‘memory’ is an example of a computer-readable storage medium. Computer memory is any memory which is directly accessible to a processor. ‘Computer storage’ or ‘storage’ is a further example of a computer-readable storage medium. Computer storage is any non-volatile computer-readable storage medium. In some embodiments computer storage may also be computer memory or vice versa.

A ‘processor’ as used herein encompasses an electronic component which is able to execute a program or machine executable instruction or computer executable code. References to the computing device comprising “a processor” should be interpreted as possibly containing more than one processor or processing core. The processor may for instance be a multi-core processor. A processor may also refer to a collection of processors within a single computer system or distributed amongst multiple computer systems. The term computing device should also be interpreted to possibly refer to a collection or network of computing devices each comprising a processor or processors. The computer executable code may be executed by multiple processors that may be within the same computing device or which may even be distributed across multiple computing devices.

Computer executable code may comprise machine executable instructions or a program which causes a processor to perform an aspect of the present invention. Computer executable code for carrying out operations for aspects of the present invention may be written in any combination of one or more programming languages, including an object oriented programming language such as Java, Smalltalk, C++ or the like and conventional procedural programming languages, such as the “C” programming language or similar programming languages and compiled into machine executable instructions. In some instances the computer executable code may be in the form of a high level language or in a pre-compiled form and be used in conjunction with an interpreter which generates the machine executable instructions on the fly.

Generally, the program instructions can be executed on one processor or on several processors. In the case of multiple processors, they can be distributed over several different entities. Each processor could execute a portion of the instructions intended for that entity. Thus, when referring to a system or process involving multiple entities, the computer program or program instructions are understood to be adapted to be executed by a processor associated or related to the respective entity.

1-15. (canceled)

16. A network node serving a user equipment in a communication system, wherein the network node comprising at least one processing core, at least one memory including computer program code, the at least one memory and the computer program code being configured to, with the at least one processing core, cause the apparatus at least to: determine the user equipment enters a survival time state for at least one data packet; in response to determining that the user equipment enters a survival time state for at least one data packet, configure the network node according to a predefined survival time configuration for reception of data from the user equipment in the survival time state.

17. The network node of claim 16, wherein determining that the user equipment enters the survival time state for the at least one data packet of an application comprises at least one of:
detecting a failure to receive at least one data packet of the application from the user equipment;
identifying a necessity of transmission of a retransmission grant or a configured grant activation command to the user equipment;
transmitting a retransmission grant or a configured grant activation command to the user equipment;
obtaining a specific status of a timer; or
obtaining a specific sequence number of at least one packet.

18. The network node of claim 16, wherein the at least one memory and the computer program code being further configured to, with the at least one processing core, cause the apparatus at least to communicate data with the user equipment in accordance with a radio interface protocol, wherein the configuring the network node is performed by activating a duplication function in one or more protocol entities of layer 2 of the radio interface protocol.

19. The network node of claim 18, wherein the duplication function is configured in a dual connectivity mode involving a secondary network node, wherein the one or more protocol entities is hosted at the network node and/or the secondary network node.

20. The network node of claim 18, wherein the one or more protocol entities comprising at least one of: medium access control (MAC) entity, radio link control (RLC) entity, and packet data convergence protocol (PDCP) entity.

21. The network node of claim 18, comprising a MAC entity, wherein the MAC entity is configured to detect the failure and, in response to the failure, send a retransmission grant of a hybrid automatic repeat request process or a configured grant activation command.

22. The network node of claim 18, comprising a PDCP entity, wherein the PDCP is configured to:
receive a notification from a protocol entity, the notification indicating that the user equipment enters the survival time state;
in response to receiving the notification, perform the activation of the duplication function in the one or more protocol entities.

23. The network node of claim 22, wherein the protocol entity is configured to send the notification upon determining that the user equipment enters the survival time state.

24. The network node of claim 22, wherein the protocol entity is configured to send the notification is a RLC entity or MAC entity.

25. The network node of claim 22, wherein the PDCP entity is configured to perform the activation of the duplication function in the RLC and/or MAC entities by sending a DL USER DATA message with an information element indicating the activation.

26. The network node of claim 22, wherein the notification is received via a F1-U interface, wherein the DL USER DATA message is sent over the F1-U interface.

27. The network node of claim 18, wherein the duplication function is configured in a dual connectivity mode with a secondary network node; wherein the notification is received via a Xn-U interface from the secondary network node; wherein the DL USER DATA message is sent over the Xn-U interface to the secondary network node.

28. The network node of claim 18, the notification being a Downlink Data Delivery Status message comprising an information element indicating that the user equipment is entering the survival time state.

29. A method comprising:
determining, by a network node, a user equipment enters a survival time state for at least one data packet,
in response to determining that the user equipment enters a survival time state for at least one data packet, configuring the network node according to a predefined survival time configuration for reception of data from the user equipment in the survival time state.

30. The method of claim 29, further comprising communicating, by the network node, data with the user equipment in accordance with a radio interface protocol, wherein the configuring the network node is performed by activating a duplication function in one or more protocol entities of layer 2 of the radio interface protocol.

31. The method of claim 30, wherein the duplication function is configured in a dual connectivity mode involving a secondary network node, wherein the one or more protocol entities is hosted at the network node and/or the secondary network node.

32. The method of claim 30, wherein the one or more protocol entities comprising at least one of: medium access control (MAC) entity, radio link control entity, and packet data convergence protocol (PDCP) entity.

33. The method of claim 30, further comprising,
receiving, by a PDCP entity, a notification from a protocol entity, the notification indicating that the user equipment enters the survival time state;
in response to receiving the notification, performing the activation of the duplication function in the one or more protocol entities.

34. The method of claim 29, wherein determining that the user equipment enters the survival time state for the at least one data packet of an application comprises at least one of:
detecting a failure to receive at least one data packet of the application from the user equipment;
identifying a necessity of transmission of a retransmission grant or a configured grant activation command to the user equipment;
transmitting a retransmission grant or a configured grant activation command to the user equipment;
obtaining a specific status of a timer; or
obtaining a specific sequence number of at least one packet.

35. The method of claim 29, further comprising, configuring a MAC entity to detect the failure and, in response to the failure, sending a retransmission grant of a hybrid automatic repeat request process or a configured grant activation command.
